(19) United States
(12) Patent Application Publication
(10) Pub. No.: US 2025/0020881 A1
(43) Pub. Date: Jan. 16, 2025

(54) GROUNDING GLAND FOR AN OPTICAL CLOSURE

(71) Applicant: Prysmian S.p.A., Milano (IT)

(72) Inventors: Nathan Paddick, Southampton (GB); Kyle Ogilbee, Bluffton, SC (US); Simon Frampton, Southampton (GB)

(21) Appl. No.: 18/770,404

(22) Filed: Jul. 11, 2024

(30) Foreign Application Priority Data
Jul. 13, 2023 (IT) 102023000014694

(51) Int. Cl. G02B 6/44; H01R 13/648

(52) U.S. Cl. CPC G02B 6/4429; H01R 13/648

(57) ABSTRACT

The present disclosure relates to a grounding gland for an optical enclosure, comprising a tubular gland body extending along an axial direction between a first end and a second end, the gland body comprising a connecting portion configured to reversibly fasten the gland body inside an opening of the optical closure; a gland base at the gland body second end, comprising one or more electrically conductive studs extending along axial directions across the gland base, such that each stud has an inner portion axially protruding inside the tubular gland body and an outer portion axially protruding outside the gland base for the electrical connection with a grounding cable; one or more terminated grounding wires, each having a proximal portion electrically connected to a stud inner portion inside the tubular gland body and a distal portion extending outside the gland body from a first opening at the gland body first end for the electrical connection to a cable to be grounded housed in the optical closure.

### CROSS-REFERENCE TO RELATED APPLICATIONS

This application claims priority to Italian Application No. 102023000014694, filed on Jul. 13, 2023, which application is hereby incorporated herein by reference.

### TECHNICAL FIELD

The present disclosure relates to the field of equipment and components for grounding armored cables housed in optical network closures, e.g. in an optical joint closure, optical network terminal, distribution box or others optical junction boxes. In particular, the embodiments of present invention relate to a grounding gland for the retrofit of an optical closure such that armor of armored cables housed inside the optical closure can be grounded.

### BACKGROUND

Typically, an optical closure comprises a base having a plurality of openings wherein a bunch of optical cables are inserted for splicing and/or to connect them to the network. Optical fibers enter into optical network closures through tubes or cables glands, which are intended to provide a safe mechanical connection of the tubes or cables to the optical network closure and to ensure a certain degree of sealing.

Sometimes, armored cables need to be housed inside optical closures and their armor needs to be grounded. To this purpose, several solutions have been proposed.

For example, U.S. Pat. No. 9,983,377 B2 discloses an enclosure for telecommunication cables including a body that defines an interior of the enclosure, a grounding base secured relative to the body, and at least one strain relief assembly having a strain relief member and grounding member that are jointly coupled to the grounding base.

WO 2021/126751 A1 discloses electrical grounding assemblies for electrically grounding cables in cable closures. A grounding unit of the grounding assembly can serve as a common ground connection to multiple cables. The grounding unit includes mounting features that allow it to be easily mounted and unmounted from a slotted base plate positioned within the cable closure.

In the above-mentioned solutions, however, the grounding base with one or more ground connections is part of the closure.

### SUMMARY

The Applicant therefore aims at providing a grounding gland which can be coupled to a classic optical closure for non-armored cables thereby achieving a retrofitting of the same for grounding armored cables housed therein. This aim is achieved by a grounding gland configured to be inserted in the opening of a classic optical enclosure used for cable glands. In this manner, it is possible to ground the cables inserted inside the closure without the need of modifying the base or the optical enclosure itself and keeping the same level of Ingress Protection, e.g. same IP code.

Accordingly, the present disclosure relates to a grounding gland for the retrofit of an optical enclosure, comprising a tubular gland body extending along an axial direction between a first end and a second end, the gland body comprising a connecting portion configured to reversibly fasten the gland body inside an opening of the optical closure; a gland base at the gland body second end, comprising one or more electrically conductive studs extending along axial directions across the gland base, such that each stud has an inner portion axially protruding inside the tubular gland body and an outer portion axially protruding outside the gland base for the electrical connection with a grounding cable; one or more terminated grounding wires, each having a proximal portion electrically connected to a stud inner portion inside the tubular gland body and a distal portion extending outside the gland body from a first opening at the gland body first end for the electrical connection to a cable to be grounded housed in the optical closure.

In an embodiment, the proximal portion of each terminated grounding wire is electrically connected to a stud inner portion of a relative stud inside the tubular gland body.

In an embodiment, the gland body connecting portion comprises a locking arrangement configured to axially lock the gland body inside the opening of the optical closure.

In an embodiment, the locking arrangement comprises one or more elastically deformable tabs on the gland body outer periphery forming snap-fits suitable to cooperate with internal walls of the optical closure opening.

In an embodiment, the gland body connecting portion comprises an anti-rotation portion forming a shape coupling with the optical closure openings for avoiding rotations of the gland body around the axial direction thereof when the grounding gland is coupled with the optical closure.

In an embodiment, the gland body further comprises a sealing portion configured for sealing the gland body inside the optical closure opening.

In an embodiment, the gland body sealing portion comprises one or more annular seats formed on the external periphery of the gland body and respective annular seals arranged therein.

In an embodiment, the tubular gland body is filled with a hardened resin.

In an embodiment, the one or more electrically conductive stud axial directions are parallel to the gland body axial direction.

In an embodiment, the one or more electrically conductive stud longitudinal directions are externally offset relative to the distal portions of the one or more grounding wires to which they are electrically connected.

In an embodiment, the grounding wire proximal portions are bended towards the periphery of the gland base and are crimped to a respective stud inner portion.

In an embodiment, the grounding wire proximal portions are unbended and soldered to a respective stud inner portion.

In an embodiment, the gland base comprises one or more stud seats and the one or more electrically conductive studs comprise anti-rotation portions forming a shape coupling with the stud seats for avoiding rotations of the studs around their axial direction.

In an embodiment, the grounding gland further comprises an electrically conductive plate electrically connecting at least two of the electrically conductive studs.

In another aspect, an optical closure comprises: a base including a plurality of openings and one or more grounding glands according to the present disclosure arranged in the optical closure openings.

### BRIEF DESCRIPTION OF THE DRAWINGS

Further characteristics and advantages will be more apparent from the following description of some embodiments given as a way of an example with reference to the enclosed drawings in which:

FIG. 1 shows a side view of grounding gland according to the present disclosure;

FIG. 2 shows an exploded perspective view of the grounding gland shown in FIG. 1;

FIG. 3 shows a sectional view taken on a longitudinal plane of the grounding gland shown in FIG. 1;

FIGS. 4 and 5 show, respectively, top and bottom views of the grounding gland in FIG. 1;

FIG. 6 shows a perspective view of a detail of the grounding gland shown in FIG. 1; and

FIG. 7 shows an exploded perspective view of the grounding gland of the present disclosure coupled to an optical closure.

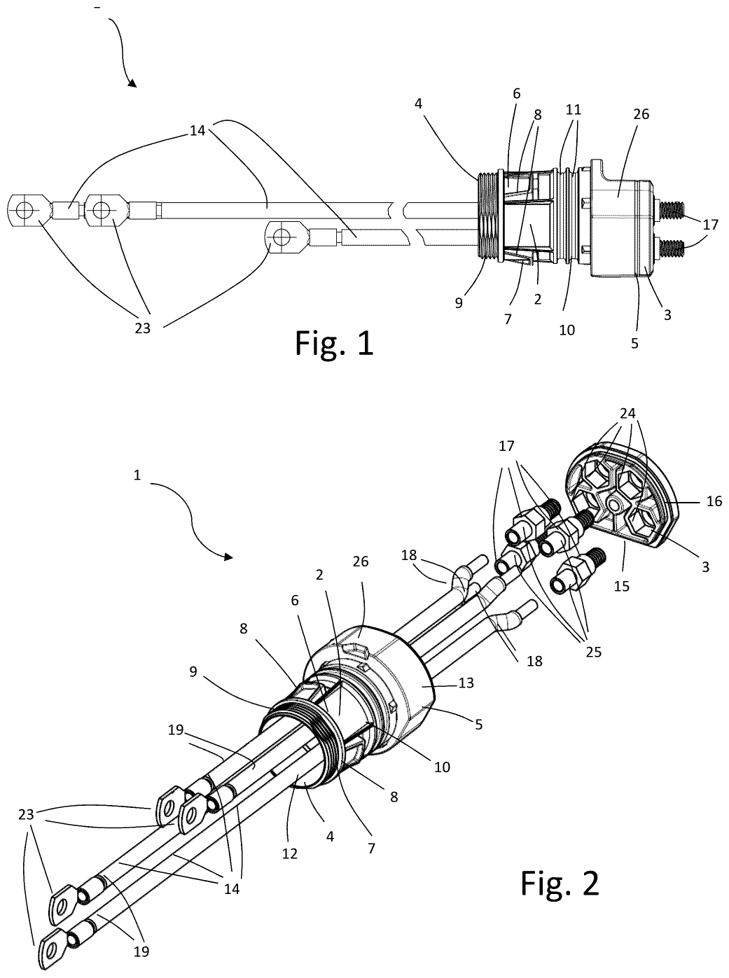

### DETAILED DESCRIPTION OF ILLUSTRATIVE EMBODIMENTS

In the following description, same alphanumeric references are used for analogous exemplary elements when they are depicted in different drawings.

For the purpose of the present description and of the appended claims, the words “a” or “an” should be read to include one or at least one and the singular also includes the plural unless it is obvious that it is meant otherwise. This is done merely for convenience and to give a general sense of the disclosure.

The present disclosure, in at least one of the aforementioned aspects, can be implemented according to one or more of the following embodiments, optionally combined together.

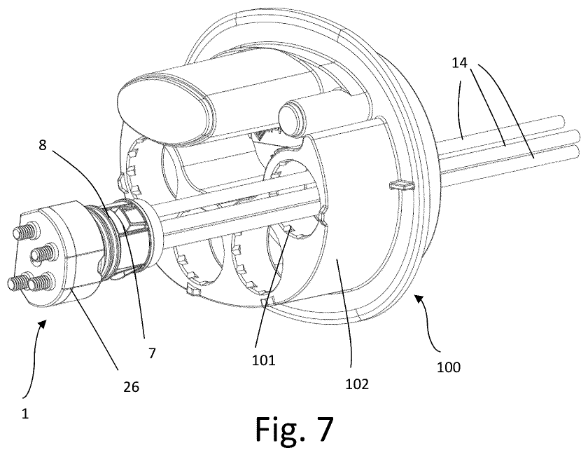

With reference to the attached Figures, a grounding gland is indicated with reference 1. The grounding gland 1 is intended to be connected to an optical closure 100, in particular to be positioned in an opening 101 thereof, for example one opening of a plurality of openings 101 provided in a base 102 of the optical closure 100 (to this regard, see FIG. 7).

The grounding gland 1 comprises a tubular gland body 2 and a gland base 3, which can be reversibly connected one to another. The gland body 2 and the gland base 3 can be made for example of a thermoplastic material, such as polyoxymethylene.

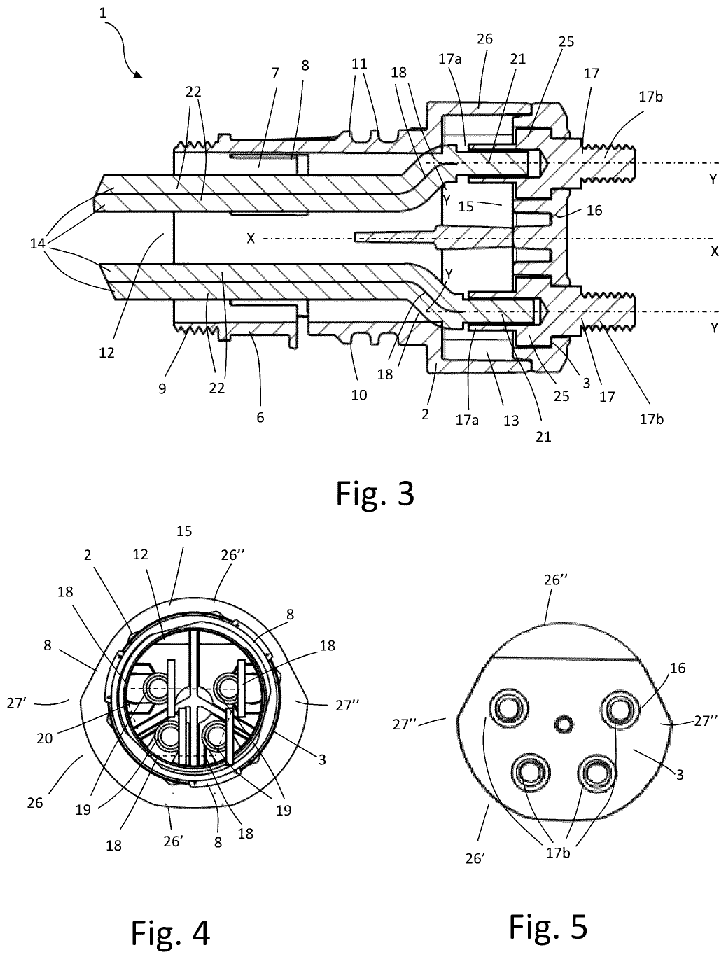

The gland body 2 extends along an axial direction X-X, as in FIG. 3, between a first end 4 and a second end 5 opposed to the first end 4. The gland body 2 comprises, for example at the first end 4, a connecting portion 6 configured to reversibly fasten the gland body 2 inside the opening 101 of the optical closure 100.

In an embodiment, the connecting portion 6 comprises a locking arrangement 7 configured to axially lock the gland body 2 inside the opening 101 of the optical closure 100. In the embodiment shown in the Figures, the locking arrangement 7 comprises on the gland body 2 outer periphery one or more elastically deformable tabs 8 forming snap-fits suitable to cooperate with internal walls of the optical closure 100 opening 101 to reversibly axially fasten the gland body 2 to the optical closure 100 in the opening 101.

In an embodiment, the optical closure 100 openings 101 and the gland body 2 are configured such that the grounding gland 1 cannot rotate inside the openings around the axial direction X-X. In the embodiment shown in the Figures, the gland body 2 comprises an anti-rotation portion 26 forming a shape coupling with the optical closure 100 openings 101 for avoiding such rotations. In an embodiment, the anti-rotation portion 26 contour comprises two opposite arcs 26′, 26″ joining at two edges 27′, 27″ (see FIGS. 4 and 5). Advantageously, the optical closure 100 openings 101 contours have a complementary shape.

In an embodiment, the connecting portion 6 further comprises at the first end 4 a threaded portion 9 configured to connect for example a blanking cap or additional attachment, if required.

In an embodiment, the gland body 2 comprises, for example between the first end 4 and the second end 5, a sealing portion 10 configured for sealing the gland body 2 inside the optical closure 100 opening 101 and for avoiding the passage of any fluid through the opening 101 when the gland body 2 is fastened therein. For example, the sealing portion 10 comprises one or more annular seats 11 formed on the outer periphery of the gland body 2 for the positioning of respective annular seals (not shown in the figures) therein.

The gland body 2 comprises at the first end 4 a first opening 12 for the passage of one or more terminated grounding wires 14, and at the second end 5 a second opening 13 for the positioning of the gland base 3. In some embodiments, the area of the first opening 12 is smaller than the area of the second opening 13. The grounding wires 14, as will be better described, are connected to the gland base 3 inside the tubular gland body 2 and exit from the gland body 2 through the first opening 12. The grounding gland 1 according to the embodiments shown in the Figures comprises for example four grounding wires 14.

The gland base 3 has an inner side 15 facing the inside of the gland body 2 and an outer side 16 opposite to the inner side 15 facing the outside of the grounding gland 1, and comprises one or more electrically conductive studs 17. Each stud extends along an axial direction Y-Y (for example parallel each other and parallel to the axial direction X-X), crossing, in some embodiments perpendicularly, the gland base 3 and comprising an inner portion 17a axially protruding from the gland base 3 inner side 15 towards the interior of the gland body 2 and an outer portion 17b axially protruding from the gland base 3 outer side 16 towards the outside of the grounding gland 1. Each stud outer portion 17b is intended to be electrically coupled to a grounding cable (not shown in the figure), whereas each stud inner portion 17a is electrically connected to a proximal portion 18 of at least one of the grounding wires 14. It is observed that, in the embodiments shown in the Figures, each single grounding wire 14 is electrically connected to a respective stud 17. However, according to other embodiments not shown in the Figures, more than one grounding wires 14 can be electrically connected to the same stud 17. The stud outer portions 17b can comprise a thread for example for locking the grounding cable by means of a nut (not shown in the Figures).

Each grounding wires 14 in turn comprises a distal portion 19 intended to be electrically coupled with a cable inside the optical closure 100 for grounding it, for example with an armor of an armored cable (not shown in the Figures). In this manner, an electrically conductive path can be established between the cable armor and the earth. In an embodiment, the grounding wires 14 comprise at their distal portions 19 conductive plates 23 for the above-mentioned electrical connections with the cables inside the optical closure 100 to be earthed.

In some embodiments, the gland base 3 comprises a plurality of studs 17 positioned near the periphery of the gland base 3. Each stud 17 is axially offset relative to the distal portion 19 of the respective grounding wire/wires 14 to which is electrically connected, in particular each stud 17 is axially externally offset relative to the respective grounding wire 14 distal portion/portions 19. In other words, when seeing the projections of the grounding wires 14 distal portions 19 on the gland base 2 inner side 15 from the gland body 2 first opening 12, their longitudinal axes fall within or along an ideal curve defined by connecting all the studs 17 longitudinal axes (see line 20 in FIG. 4, having a trapezoidal shape in the exemplary embodiment shown).

In order to connect the grounding wire proximal portions 18 to each stud 17 several alternatives are possible.

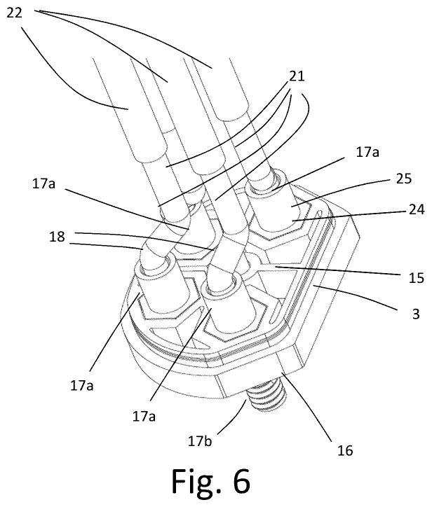

According to an embodiment (as shown in FIGS. 2-6), the grounding wire proximal portions 18 are bended towards the periphery of the gland base 3 and mechanically connected to the respective studs 17, in particular the inner portion 17a thereof. For example, the grounding wire proximal portions 18 can be crimped to the respective stud inner portion 17a.

According to another embodiment (not shown in the Figures), the grounding wire proximal portions 18 are unbended (i.e., the proximal portions and the distal portions are substantially aligned) and soldered to the respective stud inner portion 17a with a soldering, for example formed in the gland base 3 inner side 15.

It is to be noted that the grounding wires 14 can comprise a conductor 21 (e.g., in tinned copper) covered by an electrically insulating sheath 22. This insulating sheath 22 can be removed at the proximal portions 18 so that the grounding wires 14 can be electrically connected to the studs 17 as described above.

In an embodiment, the studs 17 and the gland base 3 are configured such that the studs 17 cannot rotate around their axial directions Y-Y. In an embodiment, the gland base 3 comprises respective stud seats 24 and the studs 17 comprise anti-rotation portions 25 forming a shape coupling for avoiding such rotations. For example, the anti-rotation portions 25 are nut-shaped and the stud seats 24 have a complimentary shape, e.g. a hexagonal shape.

The space inside the tubular gland body 2 between the first opening 12 and the second opening 13 (closed by the gland base 3) can be filled with a hardened resin, for example an epoxy resin, in order to ensure, in addition to the above-mentioned sealing in the sealing portion 11, a proper IP protection when the grounding gland 1 is coupled to the closure 100.

In another embodiment not shown in the Figures, the grounding gland 1 comprises an electrically conductive, e.g. metallic, plate, electrically connecting at least two of the electrically conductive studs 17, for example all of them. The electrically conductive plate, for example, can be connected to the gland base 3 at the inner side 15 or at the outer side 16 thereof.

What is claimed is:

1. A grounding gland for an optical closure, comprising:
a tubular gland body extending along an axial direction between a first end and a second end, the gland body comprising a connecting portion configured to reversibly fasten the gland body inside an opening of the optical closure;
a gland base at the second end of the gland body, comprising one or more electrically conductive studs extending along axial directions across the gland base, such that each stud has an inner portion axially protruding inside the tubular gland body and an outer portion axially protruding outside the gland base for an electrical connection with a grounding cable; and
one or more terminated grounding wires, each having a proximal portion electrically connected to a stud inner portion inside the tubular gland body and a distal portion extending outside the gland body from a first opening at the first end of the gland body for the electrical connection to a cable to be grounded housed in the optical closure.

2. The grounding gland of claim 1, wherein the connecting portion of the gland body comprises a locking arrangement configured to axially lock the gland body inside the opening of the optical closure.

3. The grounding gland of claim 1, wherein the proximal portion of each terminated grounding wire is electrically connected to a stud inner portion of a relative stud inside the tubular gland body.

4. The grounding gland of claim 3, wherein the gland body connecting portion comprises a locking arrangement configured to axially lock the gland body inside the opening of the optical closure.

5. The grounding gland of claim 4, wherein the locking arrangement comprises one or more elastically deformable tabs on an outer periphery of the gland body to form snap-fits suitable to cooperate with internal walls of the optical closure opening.

6. The grounding gland of claim 1, wherein the connecting portion of the gland body comprises an anti-rotation portion forming a shape coupling with the opening of the optical closure for avoiding rotations of the gland body around the axial direction thereof when the grounding gland is coupled with the optical closure.

7. The grounding gland of claim 1, wherein the gland body further comprises a sealing portion configured for sealing the gland body inside the optical closure opening.

8. The grounding gland of claim 7, wherein the sealing portion comprises one or more annular seats formed on an external periphery of the gland body and respective annular seals arranged therein.

9. The grounding gland of claim 1, wherein the tubular gland body is filled with a hardened resin.

10. The grounding gland of claim 1, wherein axial directions of the one or more electrically conductive studs are parallel to an axial direction of the gland body.

11. A grounding gland for an optical closure, comprising:
a tubular gland body extending along an axial direction between a first end and a second end, the gland body comprising a connecting portion configured to reversibly fasten the gland body inside an opening of the optical closure;
a gland base at the second end of the gland body, comprising one or more electrically conductive studs extending along axial directions across the gland base, such that each stud has an inner portion axially protruding inside the tubular gland body and an outer portion axially protruding outside the gland base for an electrical connection with a grounding cable; and
one or more terminated grounding wires, each having a proximal portion electrically connected to a stud inner portion inside the tubular gland body and a distal portion extending outside the gland body from a first opening at the first end of the gland body for the electrical connection to a cable to be grounded housed in the optical closure, wherein longitudinal directions of the one or more electrically conductive studs are externally offset relative to the distal portions of the one or more grounding wires to which they are electrically connected.

12. The grounding gland of claim 11, wherein the proximal portions of the grounding wires are bended towards a periphery of the gland base and are crimped to a respective stud inner portion.

13. The grounding gland of claim 11, wherein the proximal portions of the grounding wires are unbended and soldered to a respective stud inner portion.

14. The grounding gland of claim 1, wherein the gland base comprises one or more stud seats and the one or more electrically conductive studs comprise anti-rotation portions forming a shape coupling with the stud seats for avoiding rotations of the studs around their axial direction.

15. The grounding gland of claim 1, further comprising an electrically conductive plate electrically connecting at least two of the electrically conductive studs.

16. An optical closure comprising:
a base including a plurality of openings; and
one or more grounding glands arranged in the plurality of openings, the one or more grounding glands comprising:
a tubular gland body extending along an axial direction between a first end and a second end, the gland body comprising a connecting portion configured to reversibly fasten the gland body inside an opening of the optical closure;
a gland base at the second end of the gland body, comprising one or more electrically conductive studs extending along axial directions across the gland base, such that each stud has an inner portion axially protruding inside the tubular gland body and an outer portion axially protruding outside the gland base for an electrical connection with a grounding cable; and
one or more terminated grounding wires, each having a proximal portion electrically connected to a stud inner portion inside the tubular gland body and a distal portion extending outside the gland body from a first opening at the first end of the gland body for the electrical connection to a cable to be grounded housed in the optical closure.

17. The optical closure of claim 16, wherein the connecting portion of the gland body comprises a locking arrangement configured to axially lock the gland body inside the plurality of openings.

18. The optical closure of claim 16, wherein the proximal portion of each terminated grounding wire is electrically connected to a stud inner portion of a relative stud inside the tubular gland body.

19. The optical closure of claim 18, wherein the gland body connecting portion comprises a locking arrangement configured to axially lock the gland body inside the opening of the optical closure.

20. The optical closure of claim 16, wherein the connecting portion of the gland body comprises an anti-rotation portion forming a shape coupling with the openings of the optical closure for avoiding rotations of the gland body around the axial direction thereof when the grounding gland is coupled with the optical closure.
